(19) United States
(12) Patent Application Publication
(10) Pub. No.: US 2015/0254889 A1
(43) Pub. Date: Sep. 10, 2015

(54) Method and System for a Separated Shadowing in Ray Tracing

(71) Applicant: Reuven Bakalash, Shdema (IL)

(72) Inventor: Reuven Bakalash, Shdema (IL)

(21) Appl. No.: 14/538,812

(22) Filed: Nov. 12, 2014

Related U.S. Application Data
(63) Continuation-in-part of application No. 13/726,763, filed on Dec. 26, 2012, now Pat. No. 8,957,902.
Application No. 13/726,763 is a continuation-in-part of application No. 14/479,336, filed on Sep. 7, 2014, now abandoned.
Application No. 14/479,336 is a continuation-in-part of application No. 14/479,324, filed on Sep. 7, 2014.
Application No. 14/479,324 is a continuation-in-part of application No. 14/479,320, filed on Sep. 7, 2014.
(60) Provisional application No. 61/910,305, filed on Nov. 30, 2013.

(51) Int. Cl. G06T 15/06; G06T 15/60

(52) U.S. Cl. CPC G06T 15/06; G06T 15/60; G06T 2215/12; G06T 2200/04

(57) ABSTRACT

The present disclosure describes a new ray tracing shadowing method. The method is unique as it separates the shadowing from the tracing stages of primary and secondary rays. It provides high data locality, reduced amount of intersection tests, no traversals and no reconstruction of complex acceleration structures, as well as improved load balancing based on actual processing load.

### CROSS-REFERENCE TO RELATED CASES

The present application claims priority based on U.S. Provisional Applications No. 61/910,305 filec. Nov. 30, 2013 entitled “Locality-enhanced Shadowing in Ray Tracing”; and is a Continuation-In-Part of the U.S. application Ser. No. 13/726,763 filed Dec. 26, 2012 entitled “Method and Apparatus for Interprocessor Communication Employing Modular Space Division”, and is a Continuation-In-Part of the U.S. application Ser. No. 14/479,336filed Sep. 7, 2014entitled “Stencil Mapped Shadowing System”, and is a Continuation-In-Part of the U.S. application Ser. No. 14/479,324, filed Sep. 7, 2014, entitled “Ray Shadowing System Utilizing Geometrical Stencils”, and is a Continuation-In-Part of the U.S. application Ser. No. 14/479,320, filed Sep. 7, 2014, entitled “Ray Shadowing Method Utilizing Geometrical Stencils”, all of which are hereby incorporated by reference.

### FIELD OF THE INVENTION

The present invention relates generally to solving data-parallel processing and, more particularly, to data-parallel ray tracing technology enabling real time applications and highly photo-realistic images.

### BACKGROUND OF THE INVENTION

Ray-tracing is a technique for generating images by simulating the behavior of light within a three-dimensional scene by tracing light rays from the camera into the scene, as depicted in FIG. 1.

Generally, two types of rays are used. The ray that comes from the screen or viewer's eye (aka point of view) is called the primary ray. Tracing and processing the primary ray is called primary ray shooting, or just ray shooting. If the primary ray hits an object, at the primary point of intersection, the light may bounce from the surface of the object. We call these rays, secondary rays or bouncing rays. Primary rays are traced from a particular point on the camera image plane (a pixel) into the scene, until they hit a surface, in a so-called hit point(HIP). Shadow rays are traced from a hit point to determine how it is lit. The origin of a shadow ray is on the surface of an object and it is directed towards the light sources. If the ray hits any object before it reaches any light source, the point located at the ray origin is in the shadow and should be assigned a dark color. Processing the shadow ray is called shadowing.

Finally, to determine how the surface material appears texture lookups and shading computations are performed at or near the hit point. FIG. 2 shows a scene having three objects and a single light source. Three ray generations are created when the primary ray spawns other rays (N′ surface normal, R′ reflected ray, L′ shadow ray, T′ transmitted (refracted) ray).

Ray tracing is a computationally expensive algorithm. Fortunately, ray tracing is quite easy to parallelize. The contribution of each ray to the final image can be computed independently from the other rays. For this reason, there has been a lot of effort put into finding the best parallel decomposition for ray tracing. There are two main parallelization approaches in the prior art: (i) ray-parallel, in which rays are distributed among parallel processors, while each processor traces a ray all the way, and (ii) data-parallel, in which the scene is distributed among multiple processors, while a ray is handled by multiple processors in a row.

The ray-parallel implementation of ray tracing would simply replicate all the data with each processor and subdivide the screen into a number of disjoint regions. Each processor, then renders a number of regions using the unaltered sequential version of the ray tracing algorithm, until the whole image is completed. Whenever a processor finishes a region, it asks the master processor for a new task. This is also called the demand driven approach, or an image space subdivision. Load balancing is achieved dynamically by sending new tasks to processors that have just become idle. However, if a very large model needs to be rendered, the scene data have to be distributed over the memories, because the local memory of each processor is not large enough to hold the entire scene. Then demand driven approach suffers from massive copies and multiplications of geometric data.

Data-parallel is a different approach to rendering scenes, used mostly for large data cases that do not fit into a single processor's memory. The object data is distributed over the processors. Each processor owns only a subset of the database and it traces rays only when they pass through its own subspace. Its better data locality excludes massive moves of data, addressing the needs of very large models. However, rendering cost per ray and the number of rays passing through each subset of the database are likely to vary (e.g. Hotspots are caused by viewpoints and light sources), leading to severe load imbalances, a problem which is difficult to solve either with static or dynamic load balancing schemes. Efficiency thus tends to be low in such systems.

According to data-parallel shadowing of prior art, for each single hit point (primary or secondary) many negative intersection tests are required before the positive hit is found. This is illustrated in FIG. 3, where four shadowing-rays originating at four separate hit points (HIPs), and 2 cells, are shot toward the light source (LS). Each ray must pass through intermediate cells seeking for the first obscuring triangle. All objects in ray's vicinity must be tested for intersection, summing up to many intersection tests per ray. Only the actual hit stops those tests. E.g. a shadow ray is sent from HIP1 toward LS. HIP1 is shaded by object 1, close to the LS, but it is tested for many intersections with all objects along the ray's traversal path. The shadowing ray of HIP4 performs multiple intersection tests, despite being undisturbed on the way to LS.

Evidently, the process of tracing an individual ray in the data-parallel prior art is long and sequential, extending from a HIP toward LS. E.g., in regard to HIP 1 of FIG. 3, object 2 and other objects along the path must be tested for intersection in a distance specific order, according to their distance from HIP, all before object 1. This is evidently a sequential process.

Data locality is a desirable feature in ray tracing: it reduces moves of massive data, contributes to a higher utilization of cache memories, reduces the use of main memory, and decreases interprocessor communication. In order to exploit locality some spatial subdivision is used to decide which parts of the scene are stored with which processor. In its simplest form, the data is distributed according to a uniform distribution. Each processor will hold one or more equal sized cells. Having just one cell per processor allows the data decomposition to be nicely mapped onto a 3D grid topology. However, since the number of objects may vary dramatically from cell to cell, the cost of tracing a ray through each of these cells will vary and therefore this approach may lead to severe load imbalances. Even worse, the distribution of working load is not necessarily correlated with object distribution. E.g. one large object can hide a whole group of objects, making them invisible from the view point, aka non active. Therefore, in shadowing, a load balancing according to the actual work distribution, rather than according to data distribution, would be a most desirable feature. The way the processing load is distributed over processors has a strong impact on how well the system performs. The more evenly distributed workload, the less idle time is to be expected.

The main problem in ray tracing is the high processing cost of intersection tests. For each frame, a rendering system must find the intersection points between millions of rays and millions of polygons. The cost of testing each ray against each polygon is prohibitive. A naïve approach may create an impossible number of intersections. To ease the problem, accelerating structures are in use(such as Octree, KD-tree, other binary trees, bounding boxes, etc.) to reduce the number of ray/polygon intersection tests. By use of acceleration structures, the typical cost of intersection tests is reduced. However, this improvement comes at the high cost of massive traversals, typically taking 60%-70% of a frame. In order to reduce the computational cost of the traversal, the ray coherence property has been used to tracing beams of rays instead of individual rays. Ray coherence means that similar rays are likely to intersect the same object in the environment. However, the shadowing rays have only limited coherence.

Construction of optimized structures is expensive and does not allow for rebuilding the accelerating structure every frame to support for interactive ray-tracing of large dynamic scenes. The construction times for larger scenes are very high and do not allow dynamic changes. The need to reconstruct before each dynamic frame, limits the performance, because the reconstruction typically takes longer that the frame itself.

The shadowing process in prior art runs concurrently with generation of primary and secondary rays. Whenever a HIP is found, an immediate shadowing of that HIP takes place. This relates to coherency of rays and memory footprint. Shadowing rays emitting from neighboring HIPs on a small surface area, toward a light source, are mostly coherent, enabling use of cache memories and use of bundles of rays for collective traversals of acceleration data structures, speeding up the process. A high memory footprint is saved if the HIPs are processed on the spot without the need to store them for a later processing.

Shadowing is an expensive process. The more light sources in a scene, the more expensive it is. Per each single hit point of a primary or secondary ray, multiple shadowing rays must be generated, greatly multiplying the working load. So in an application that shadowing is not essential, saving it or postponing would enable interactivity and would lower the ray tracing costs.

There are applications that would benefit from separating the shadowing process, and possibly canceling or postponing it to a post-processing stage. Such as standalone ray tracing application that allows the user to interact by modifying scene setup, characters and materials, before sending the scenes to a traditional render farm. An application example in the moving picture industry is Previsualization.

Previsualization (also known as pre-rendering or preview) is a function to visualize scenes in a filmmaking process before filming or before finalizing a ray traced sequence. Previsualization is a category of production apart from the visual effects unit. It involves using ray tracing to create rough versions of the more complex shots in a movie sequence. The pre-visualization can be sophisticated enough to look like a video game. Nowadays filmmakers are looking for quick animation software to help with the task of previsualization in order to lower budget and time constraints.

Separating the shadowing from the regular pipe of ray tracing allows directors to experiment with different staging and art direction options—such as camera placement and movement, stage direction and editing—without having to incur the costs of actual production. Moreover, the previsualized ray tracing sequence can be accurately combined with, or integrated in, another sequence, by generating shadows that match alternate light source positions or different scenes and times of day. The previsualized scenes can therefore remain valid, just the shadowing stage is added in a post-processing manner.

As shown, there is a great need in the art to devise a shadowing method in ray tracing having a reduced amount of intersection tests, reduced traversals and no reconstruction of complex acceleration structures, improved load balancing based on actual processing load, and the ability to separate the shadowing from primary and secondary rays.

### SUMMARY OF THE INVENTION

The present disclosure is based on an observation that high locality of data and processing in ray tracing, specifically in the shadowing stage of ray tracing, can contribute to reduced processing, improved load balancing, and isolation of the shadowing stage of the primary and secondary stages. High locality is achieved by taking a data-parallel approach, where a scene is subdivided into non-uniform cells, and by enhancing those cells with cell environmental data.

The paradigm of high locality is taken after the physics of holographic photography. Holography is a technique that enables a light field to be recorded on a recording medium plate (covered with photographic emulsion) and later reconstructed, making the image appearing three-dimensional. Due to high locality, each small piece of an accidently broken recording plate holds a sufficient information to enable reconstruction of the whole image, albeit in a lower resolution. Analogically to holography, the present invention takes the data-parallel approach in which the autonomous computable unit of the scene space is a cell, analogous to the broken piece of a holographic plate.

Cell enhancement by relevant environmental data is done by registering these data in a shadow stencil. The shadow stencils are generated in a shadowing preprocessing step, prior to shadowing. For each cell the stencils accrue the visibility of all objects situated between the light source and the cell, as they are seen from the light source.

The present disclosure relates to a method, a computer program product and computer system for shadowing in ray tracing, by determining the visibility of a hit point (HIP) from a light source. The HIPs are results of the preceding primary and secondary (bouncing) stages of ray tracing. HIPs,that are hidden from a light source by an obstructing object, are marked as shadowed. The light blocking areas are registered on a shadowing stencil, enabling locality for the shadowing decision. The method may be computer implemented and may be implemented in a computer program. The method comprises the steps of: (a) delaying shadowing upon completion of primary and secondary ray tracing stages; (b) subdividing the space to non-uniform cells, according to the light source and the actual load of HIPs, such that HIPs are evenly distributed among cells. An even distribution of hit points among cells assists in static load balancing of working load;(c) generating shadow stencils in cells; (d) assigning processing resources to a cell; (e) shadowing all HIPs in a cell; Steps (d) and (e) are repeated for all cells until shadowing of all scene space is completed.

Three shadowing embodiments are disclosed: (a) Hard Shadowing characterized by sharp, alised appearance of shadows; (b) AAed Shadowing with soft shadow appearance; and (c) Facilitated AAed Shadowing in which edge shadows are antialised at a cost of a lower accuracy.

This new approach for the ray tracing shadowing led to a method, a computer program product and a computer system that represents a major improvement in ray-tracing in the following areas:
i. Distributed parallelism. By abandoning the centralized acceleration structures, and making the required data available locally in a cell, independently of other cells, a true distributed parallelism becomes possible. The scalability with this type of parallelism is linear.
ii. Reduced processing. There are no traversals of large acceleration structures for shadowing. Intersection tests, the most expensive task in ray tracing, are radically cut down.
i. Reduced communication. Because of the locality of data and tasks, the inter-cell and inter-processor communication is greatly reduced.
ii. Cache and memory use. The effective use of cache, and reduced memory access are based on high locality of data, instead of on the limited coherence of shadowing rays. There is no need for massive access to central acceleration structures, greatly reducing dependency on main memory
iii. Reduced power and energy saving are accrued by reducing processing and decreasing memory access. This feature is of great importance in the use of all computing systems, and particularly in mobile systems.
iv. Effective load balance is enabled by locality; optimizing resource use, maximizing throughput, minimizing response time, and avoiding overload of any one of the resources. The design of balance is based on an even distribution of actual load among processing resources, instead of a mere distribution of objects (which does not reveal the true processing loads).
v. Locality allows isolation of the shadowing as a last and separate stage in ray tracing, decoupled from the primary and secondary stages, a desirable approach for many applications.

The disclosed ray tracing method can be efficiently mapped on off-the-shelf architectures, such as multicore CPU chips with or without integrated GPUs, discrete GPUs, distributed memory parallel systems, shared memory parallel system, networks of discrete CPUs, PC-level computers, information server computers, cloud server computers, laptops, portable processing systems, tablets, Smartphones, and essentially any computational-based machine. Basically, there is no necessity of special purpose hardware, however different embodiments comprising special purpose hardware can additionally speed up the performance or reduce energy.

The above summary is not exhaustive. The invention includes all systems and methods that can be practiced from all suitable combinations and derivatives of its various aspects summarized above, as well as those disclosed in the detailed description below and particularly pointed out in the claims filed with the application. Such combinations have particular advantages not specifically recited in the above summary.

### BRIEF DESCRIPTION OF THE DRAWINGS

The invention is herein described, by way of non-limiting examples, with reference to the accompanying figures and drawings, wherein like designations denote like elements. Understanding that these drawings only provide information concerning typical embodiments and are not therefore to be considered limiting in scope:

FIG. 1. Prior art. The figure illustrates a setup of a ray-traced scene, including view point, image surface and scene object. Reflection, refraction, and shadow rays are spawned from a point of intersection between primary ray and scene object.

FIG. 2. Prior art. Another setup of a ray traveling across the scene is shown, having three objects and single light source. Three ray generations are created when the primary ray spawns other rays. Terms include N′ surface normal, R′ reflected ray, L′ shadow ray, T′ transmitted (refracted) ray.

FIG. 3. Prior art. Multiple intersection tests per ray.

FIG. 4A. Hit point (HIP) generated by a primary ray.

FIG. 4B. Hit point generated by a secondary ray.

FIG. 5A. HIP and a shadow stencil map.

FIG. 5B. Shadowing HIPs according to the embodiment of hard shadows.

FIG. 5C. Antialised embodiment. Grades of gray given to edge located HIPs, post intersection tests.

FIG. 5D. Gray-level shaded HIPs of the FAAed embodiment.

FIG. 5E. Gray-level shaded edge-located HIPs in the FAA embodiment. Single shadowing object is

FIG. 6. Set up of antialised shadowing. HIPs are gray leveled on shadow's edge.

FIG. 7. HIP's surrounding fragments shaded by two different objects. Intersection test is necessary.

FIG. 8A. Six possible quadruple setups in cases of multiple light-blocking objects, (a) 2 objects, (b) 3 objects, and (c) 4 objects.

FIG. 8B. Shadowing results of the case of FIG. 7A for the antialised shadowing embodiment.

FIG. 9. Shadowing at different resolutions.

FIG. 10A. Generation of S-stencil is shown.

FIG. 10B. Use of S-stencil for shadowing HIPs.

FIG. 11. Division of the scene space into shadow processing cells.

FIG. 12AA flowchart of shadowing a HIP in a cell, hard shadowed embodiment.

FIG. 12B. A flowchart of shadowing a HIP in a cell, antialised shadowing embodiment.

FIG. 12C. Shadowing a HIP in a cell, FAA embodiment.

FIG. 12D. Flowchart of shadow processing of a light source.

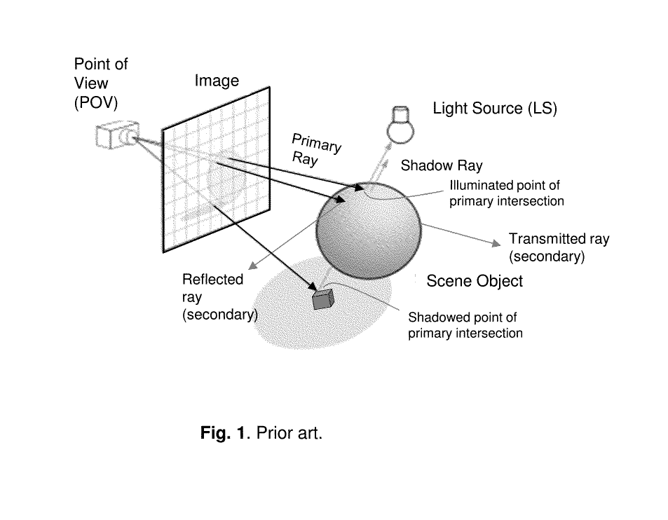

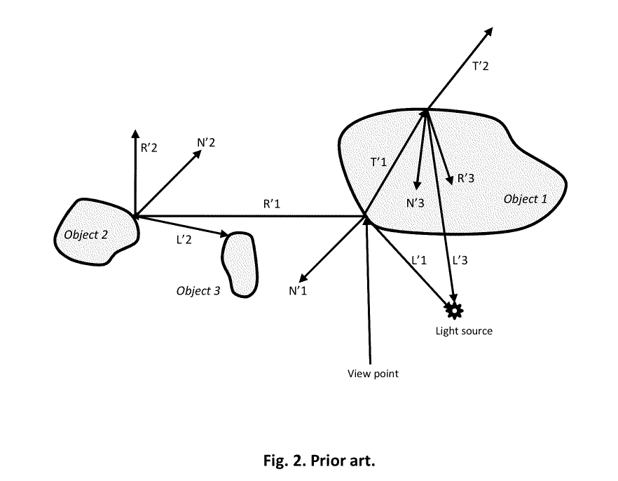

### DETAILED DESCRIPTION OF THE PREFERRED EMBODIMENTS

Unless specifically stated otherwise, as apparent from the following discussions, it is appreciated that throughout the specification discussions, utilizing terms such as “processing”, “computing”, “calculating”, “generating”, “creating” or the like, refer to the action and/or processes of a computer or computing system, or processor or similar electronic computing device, that manipulate and/or transform data represented as physical, such as electronic, quantities within the computing system's registers and/or memories into other data, similarly represented as physical quantities within the computing system's memories, registers or other such information storage, transmission or display devices.

Embodiments of the present invention may use terms such as processor, computer, apparatus, system, sub-system, module, processing element (PE), multicore, FPGA, GPU and device (in single or plural form) for performing the operations herein. This may be specially constructed for the desired purposes, or it may contain a general purpose computer selectively activated or reconfigured by a computer program stored in the computer. Several technical terms which are specifically associated with our disclosure are herein defined.

Empty cell—is a cell without objects, as opposed to a data-fill cell or polygon populated cell.

Object—a scene is made up of objects. Object can stand for a primitive (polygon, triangle, solid, etc.), or a complex object made up of primitives.

Hit point—a point where a ray intersects an object. Termed also HIP.

Shadow Stencil—stencil holding identification of light blocking objects between light source and a cell.

S-stencil—implementation of shadow stencil, a raster of discrete fragments SFs, wherein each fragment keeps alight blocking data: shadowed or lit, blocking object's identification and depth.

Visible object—is an object which is visible, at least in part, from the point of view. It is not fully hidden by other objects.

Load balancing—distributing workload across multiple processors to achieve optimal resource utilization, maximize throughput, minimize response time, and avoid overload.

Static load balance—All information is available to scheduling algorithm, which runs before any real computation starts.

Shared memory system—parallel computing system having memory shared between all processing elements in a single address space.

Distributed memory system—parallel computing system in which each processing element has its own local address space.

Private memory—when in distributed memory systems the memory is also physically distributed, each processing element has its own private memory.

Local objects—objects residing wholly or partly in a cell.

High locality. In the data-parallel approach we take, the scene is subdivided into non-uniform cells, according to the actual HIP load. It has been enabled by decoupling the shadowing from the previous ray tracing stages. As this space subdivision takes place after primary and secondary stages, the actual load is already known. The cells are distributed amongst processors for accomplishing the shadowing task. Each processor will hold one or more cells. The space is handled without the use of acceleration structures.

According to one aspect of the present invention a cell is enhanced for high locality, by making it completely independent of other cells. An enhanced locality of a cell is achieved by pre-feeding a cell with spatial information, relevant to shadowing of all local HIPs in regard to a given light source. The spatial information is fed to a proprietary shadow stencils (S-stencils), as a preparatory step to shadowing. The shadow stencil holds the spatial information of light source and light blocking objects, needed to perform the shadowing within a cell. An inter-cell communication (in shadowing) is eliminated by the use of enhanced locality.

Besides enabling distributed parallelism and reducing inter-processor communication cost, enhanced locality contributes to a reduced amount of intersection tests, the most expensive task of ray tracing. In the intermediating space between a given cell and a given light source there is only a finite amount of potentially obstructing objects (e.g. triangles). In prior art this intermediating space is repeatedly rendered for obstruction, for each HIP. According to one aspect of the present invention, this intermediating space is pre-rendered only once, the result is stored as an S-stencil within the cell, and recurrently used for all local HIPs.

Therefore, according to some aspects of the present invention, the shadowing is characterized by three features: (i) the amount of intersection tests is drastically cut down, (ii) tracing a shadowing ray per HIP is completely local to the cell, and (iii) shadowing is decoupled from the primary and secondary ray tracing.

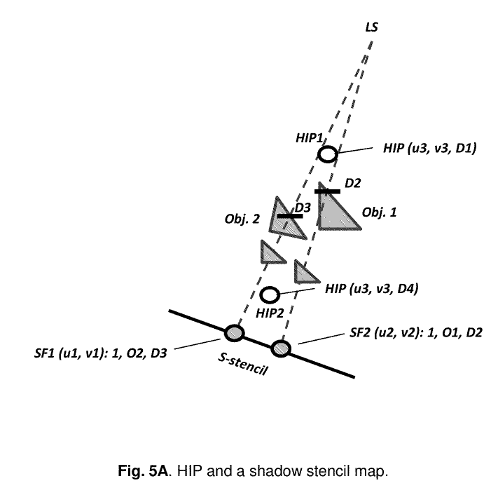

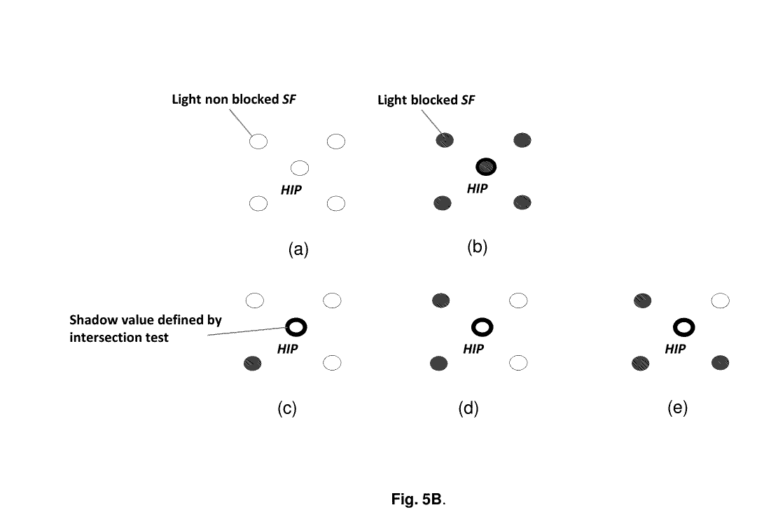

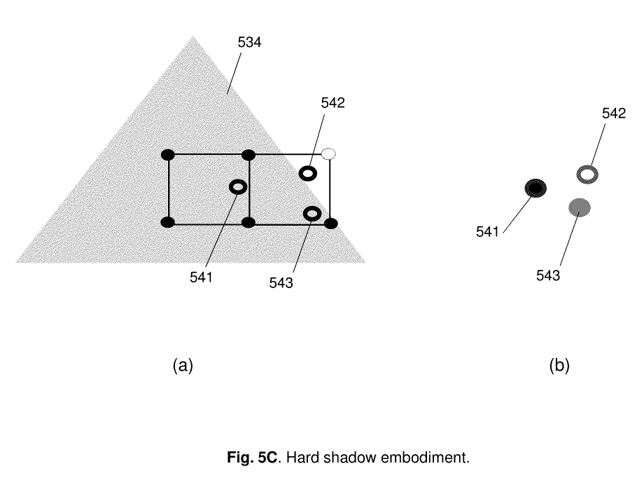

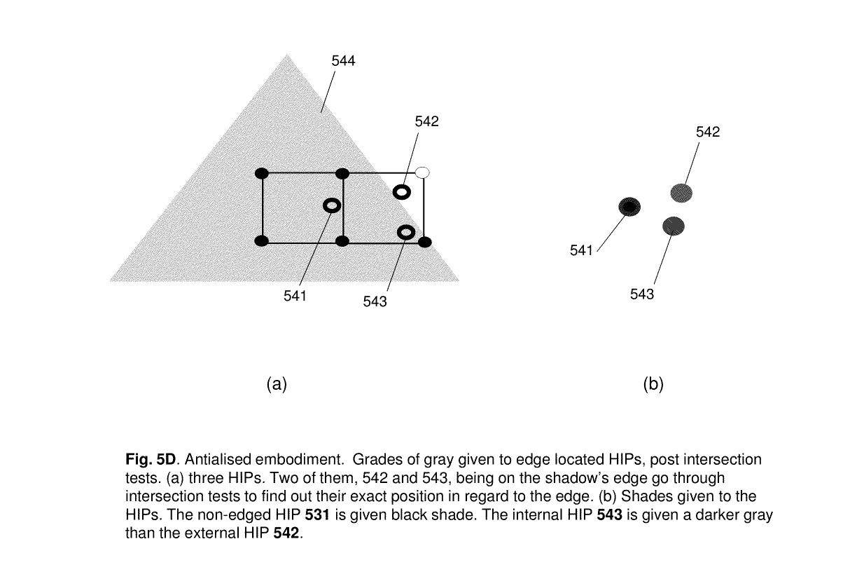

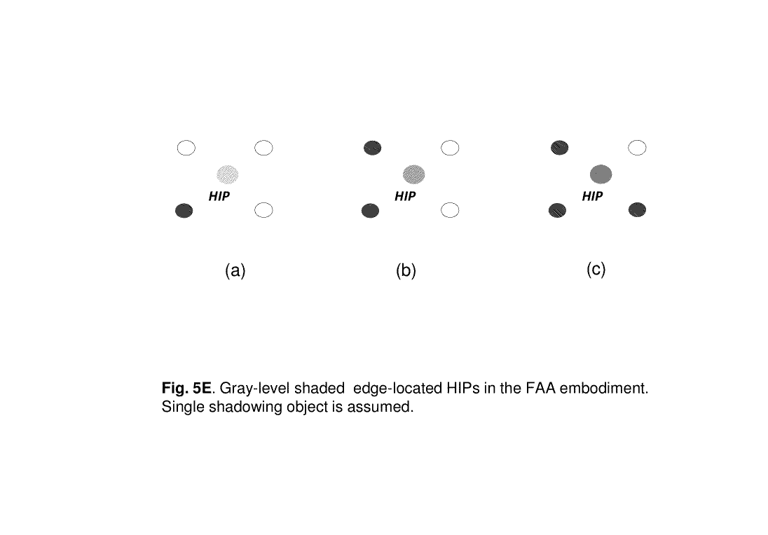

Enhancing the locality is based on providing locally at a cell all the information concerning the potentially obstructing objects, between the cell and the light source (LS). This information, stored once in a shadowing stencil (S-stencil), replaces multiple reach outs from cell's hit points to LS. The shadow stencil is a 2D layer, holding shadowing information in regard to a specific light source and the cell. In one embodiment, it is implemented as a discrete raster of fragments, each fragment holding a shadowing information on its location, of shadowed/lit and ID of the shadowing object, as depicted in FIG. 5a. The part of the S-stencil belonging to a cell would be preferably stored locally, or outside a cell, but easily and independently accessible by the cell's assigned processor. The shadowing decision per each hit point is then made locally by accessing the S-stencil. If a more accurate shadowing result is required, beyond the discrete accuracy, a consequent intersection test is performed in a continuous 3D space between the geometrically defined HIP and primitive, strictly preserving the geometrical correctness of the shadow.

As explained thereafter in great detail, enhanced locality of the shadowing process enables independence and distributed parallelism among cells. During the shadowing preprocessing stage each cell is equipped with a shadow stencil (S-stencil). Per each light source a proprietary sub-division of the scene into cells, and S-stencil in each cell are generated. The depth value and object's ID of the obscuring primitives, are generated from the LS view point. This is principally different from a single layer depth map (e.g. Feng Xie et al, Soft Shadows by Ray Tracing Multilayer Transparent Shadow Maps, 2007), by including identifiers of the obstructing primitives. Use of the S-stencil discrete maps replaces the expensive prior art's task of repeatedly out reaching the light sources by shadow rays, generated at each HIP per each LS. The use of S-stencil solves the shadowing by a conferring with the S-stencil, easily available.

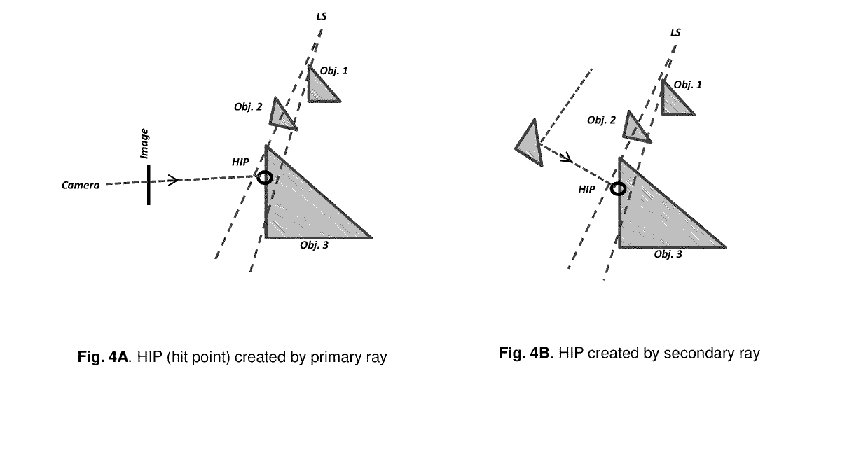

The shadowing stage comes after the primary and secondary stages. Each one of these pre-shadow stages generates hit points which are handled for shadowing. FIG. 4A shows a HIP as a result of hitting a primitive by a primary ray. FIG. 4B shows a comparable HIP generated by a secondary ray. In both cases the HIP should be resolved for shadowing in the same way; by testing for visibility in regard to the light source. In the given example, three primitives Obj.1-Obj.3 are potential candidates to block the LS light.

The shadowing principle of present invention is described in FIG. 5A. The LS visibility information is pre-stored in an S-stencil. The S-stencil is a raster of discrete fragments SFs, wherein each fragment keeps light blocking data in the form of: SF (u, v): 1/0, O, D. The parameters u and v are fragment's 2D coordinates, 1/0 indicates on shadowed or lit, respectively, and in the case of shadowed (1) the blocking object's ID is O, and D is its depth. The HIP's shadowing status is interpreted from the S-stencil by examining its surrounding quadruple of four closest fragments (in 3D). The two HIPs of FIG. 5A fall between the fragments SF1 and SF2 (for clarity only 2 out of 4 closest fragments are shown in the 2D drawing), both HIPs are having the same u3 and v3 coordinates. The SF1 and SF2 are light-blocked by the primitives Obj.2 and Obj.1, at depths D3 and D2 respectively. HIP1, having a depth D1 smaller than the depths D2 and D3, registered in SF2 and SF1 respectively, is not shadowed. HIP2, on the other hand, having depth D4 bigger than D2 and D3, falls in a shadow. A 3D setting describing a HIP positioned relatively to the surrounding quadruple of SFs, is shown in FIG. 5B. Five cases are shown. In two cases all SFs are uniform, either shaded (a) or non-shaded (b), and the shadowing decision is trivial. However, in the other cases an intersection test, between the HIP and one of the primitives registered in the shadowed SFs, might be instrumental in making a decision. However, such a decision can be made in different ways.

We disclose different embodiments of decision making. In one embodiment, termed Hard Shadowing, the resulting shadows are hard and accurate. The shadowing decision is made by performing mandatory intersection tests, except of two clear cases; when all SFs of a quadruple are lit, or when all SFs of a quadruple are shadowed by the same object. This embodiment is characterized by sharp, alised shadows. In another embodiment, termed AAed Shadowing, the edge located HIPs are being antialised. The amount of intersection tests is the same as in the hard shadows embodiment. Yet another embodiment, according to which the edge shadows are antialised at the cost of lower accuracy, is called Facilitated AAed Shadowing (FAA shadowing). Many intersection tests are saved according to this embodiment.

For simplicity, we use the terms black and white for binary shaded and lit HIPs (and SFs) respectively, however, practically any other shades and colors can be applied as well. The term gray level can be applied to shading levels between those shades and colors. It is also noteworthy to state that the antialiasing of shadows has nothing to do with antialiasing the final image, which is done in a completely different way, described elsewhere.

The S-stencil resolution should be high enough comparing to the size of primitives, in order to eliminate cases when a very small primitive hides between 4 SFs. Is such a rate is observed, then if four surrounding SFs are white, the HIP would be white as well. Similarly, when all surrounding SFs are black, the HIP would be surely black. Otherwise, the primitives' IDs at the SFs must be checked. Only if all quadruple's SFs are blocked by the same primitive, the result of 4 black SFs is a certainly shadowed HIP. So the cost of a non-adequate S-stencil resolution is an extra processing.

The Hard Shadowing embodiment is depicted in FIG. 5B. Assuming an adequate resolution, the cases (a) and (b) are unequivocal, the first one is a non-shadowed case, and the second one is a shadowed one. The other cases c, d and e can have either result, shadowed or lit, because of being blocked only partly. The way to make a correct decision is by making intersection test between the HIP and the partly blocking objects, which IDs are known from SFs. The result is strictly binary: the HIP becomes either lit or shadowed. As shown in FIG. 5B, the final result in cases c-e is unknown unless the intersection test is completed. Since the intersection test is performed in a continuous 3D space between the line emitting from the geometrical location of HIP and the geometrically defined object, the accuracy is not affected by the discrete character of S-stencil. The point of intersection is accurate, and the shadowing result is absolutely correct.

The result of hard shadowing is shown in FIG. 5C. There are shown: a single shadowing object 534, 6 SFs and 3 shadowed HIPs. HIP 531 is located inside a primitive. All its four related SFs are black, therefore the HIP is categorized as shadowed. This would be correct for all HIPs inside the primitive. Given that the resolution of S-stencil is high enough in regard to the smallest primitives, all inner, non-edgy HIPs can be categorized as shadowed without performing intersection tests. HIPs with 1-3 black surrounding SFs are edgy HIPs. They are treated for intersection tests. HIP 533 is on the inner side of the primitive's edge. The intersection result with 3 of the surrounding quadruple SFs marks it as shadowed. HIP 532 is on the outer side of the primitive's edge, the intersection result marks it as lit. Consequently, the shaded HIPs are either black or white, no intermediate gray hues. The hard shadowing creates sharp and aliased shadows, because the shadowing result is binary, leaving the final image unrealistically sharp and defined. In the prior art, other ray tracing techniques has been invented to create soft shadows, cast by non-point light sources, such as beam tracing, cone tracing, and distributed/stochastic ray tracing. Unfortunately, all these techniques are restraining expensive. Therefore, it would be desirable to create shadows with softened appearance, even if they are cast by a point light source.

The AAed Shadowing embodiment overcomes the hard shadow drawback at a low cost. The resulting shadows are antialiased. It is noteworthy that there is a difference between soft shadows and antiallised shadows. According to a true soft shadow technique, there are three distinct parts of a shadow: the umbra, penumbra and antumbra, created by any light source after impinging on anopaque object. For a point source only the umbra is cast. Our AAed Shadowing embodiment casts softened umbra shadows, no penumbra or antumbra.

The softened shadows are generated by performing the same intersection tests to the edgy HIPs as in the hard shadow embodiment, but shading them in gray levels. Three HIPs are shown in FIG. 5D (a). A single shadowing object 534 is assumed. 541 is certainly an internal HIP, since it is surrounded by 4 shaded SFs in its quadruple. Two others, 542 and 543, are edgy HIPs. They have to undergo an intersection test to find out their exact position in regard to the edge. (b)Gray shades are given to the HIPs, according to the number of surrounding black SFs. The inner HIP 541 is given a black shade. The internal-edgy HIP 533 is given a dark gray, and the external-edgy HIP 532 is given a light gray.

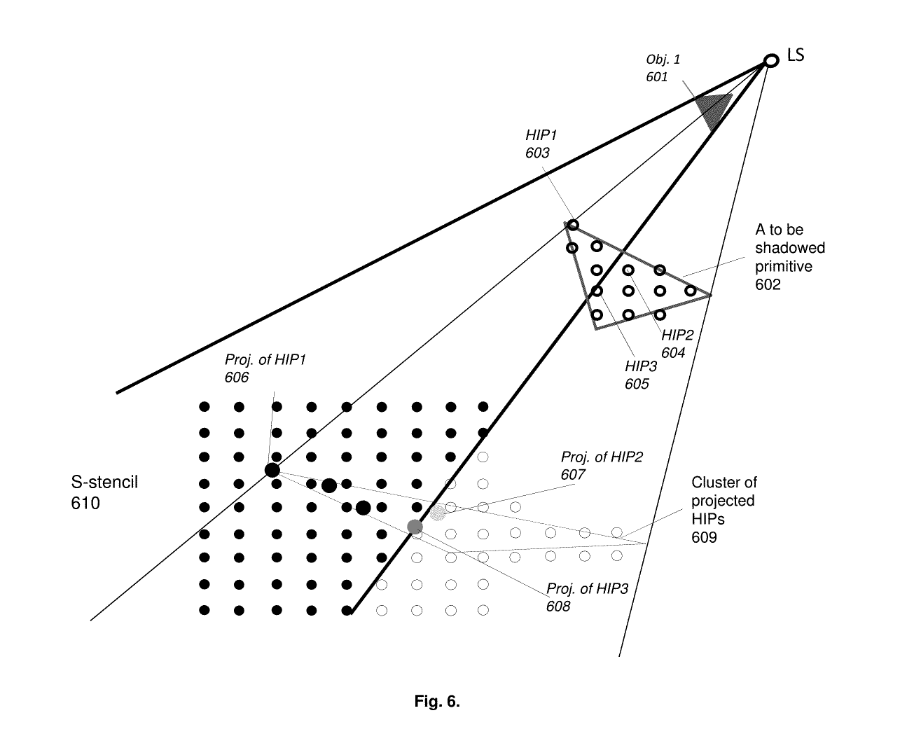

The Facilitated AAed Shadowing (FAA) is an embodiment that saves intersection-tests. Given that the S-stencil resolution is adequate, in the uncertain cases, when a HIP is surrounded by 1,2 or 3 shadowed SFs, the HIP can be shaded in one of three levels of gray, as shown in FIG. 5E, without performing intersection tests. It means that we do not differentiate between the inner and outer location of edgy HIPs, as opposed to what we did with 542 and 541 in FIG. 5D. The creation of antialised shadowing is shown in FIG. 6. The S-stencil 610 is shown as a discrete grid that registers the identity and depth of blocking primitives. A cluster of to be shadowed HIPs 602 is shown, and their projection 609 on the S-stencil. Three HIPs of this cluster are particularly tracked, HIP1 603, HIP2 604, and HIP3 605. The HIPs are projected on the S-stencil, each having a quadruple of SF neighbors. HIP1 603 is shadowed in black, since its projection 606 is surrounded by 4 black SFs. The projected HIP2 607 has only 1 black SF in its quadruple, therefore it gets a low gray shade. The projected HIP3 608 is surrounded by 3 black SFs, getting a deep gray shade. The amount of intersection tests in this embodiment is greatly reduced. Given that the S-stencil is of a correct resolution as related to primitives, no intersection tests must be performed.

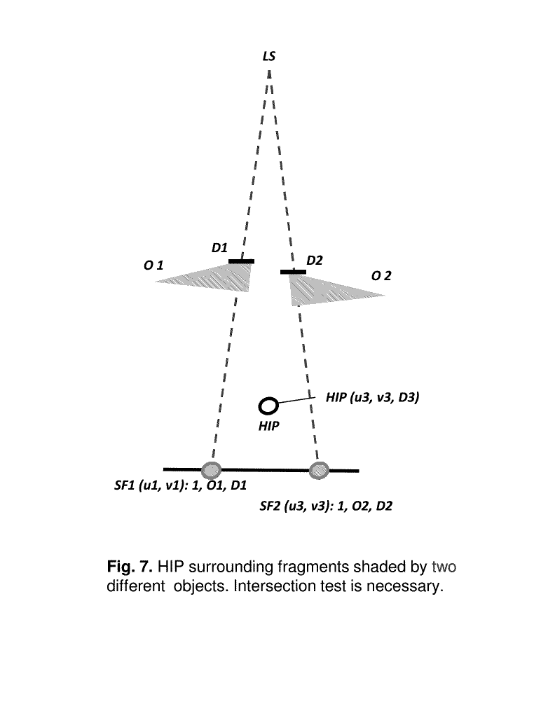

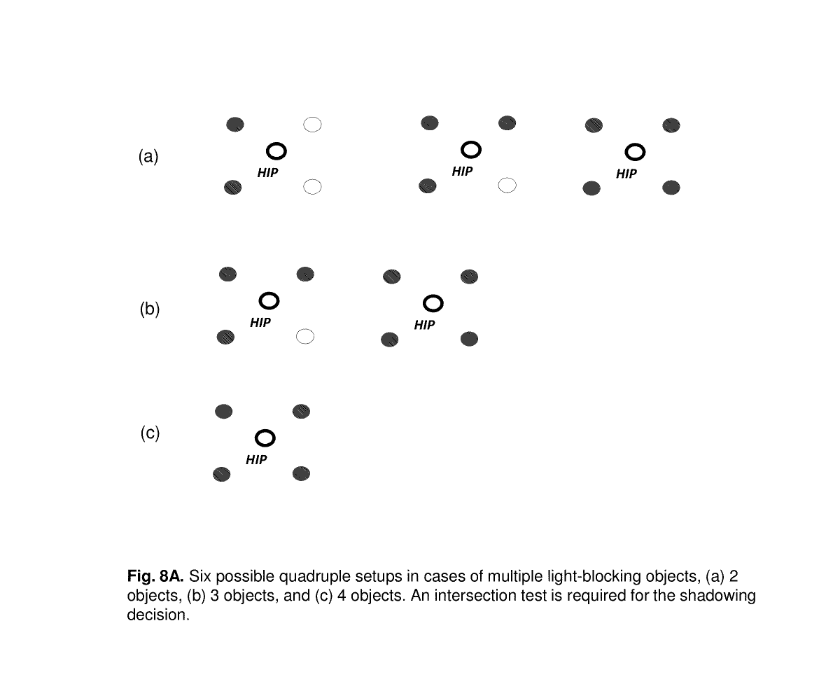

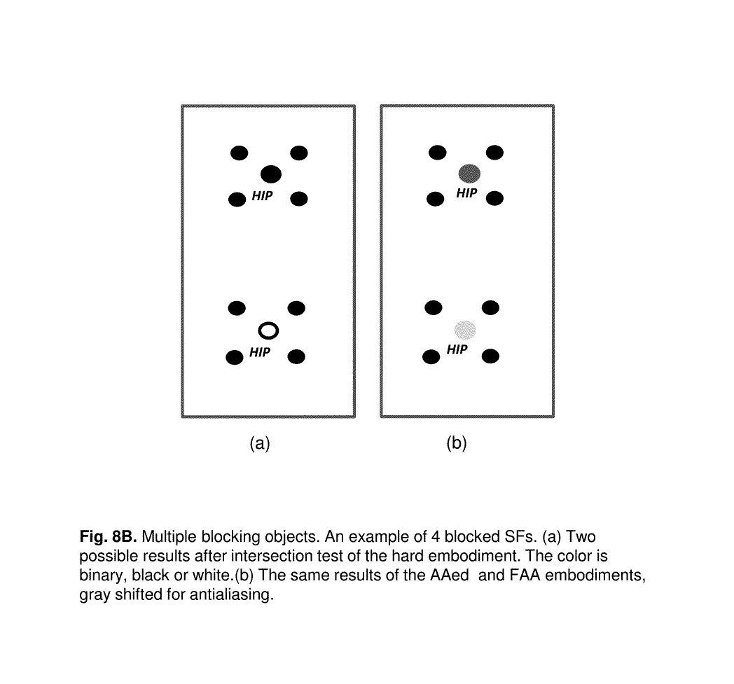

However, if the S-stencil resolution is not satisfactory, then testing blocking IDs and making additional intersection tests become necessary, for all embodiments. This is demonstrated in FIG. 7. Two SFs of a quadruple are blocked by two separate objects. Even if all SFs are shadowed, the HIP might still fall in between the objects, remaining mistakenly not shadowed. Therefore, the shadowing result depends on the exact HIP position in regard to the SFs. This accurate position must be found by intersection tests with all participating objects. In FIG. 8A six possible quadruple setups are shown in the cases of multiple light-blocking objects, (a) 2 objects, (b) 3 objects, and (c) 4 objects. The highest number of intersection tests is needed in a setup of 4 light-blocking objects. The required number of intersection tests for a multiple light-blocking objects is: (i) for 2 shadowed SFs by 2 different objects, 2 intersection tests are needed, (b) for 3 shadowed SFs by 3 different objects, 3 intersection tests are needed, and (c) for 4 shadowed SFs by 4 different objects, four intersection tests are needed. Other combinations can apply as well, requiring less intersection tests, e.g. case c with only 2 objects need 2 intersection tests. In general, the amount of intersection tests yields the number of participating objects.

An example of a quadruple of 4 SFs blocked by multiple objects is brought in FIG. 8B. Two results after intersection tests are possible, the HIP is in shadow, or is lit. (a) In the hard embodiment the color is binary, black or white.(b) In the AAed or FAA embodiments the same intersection results are gray shifted for antialiasing.

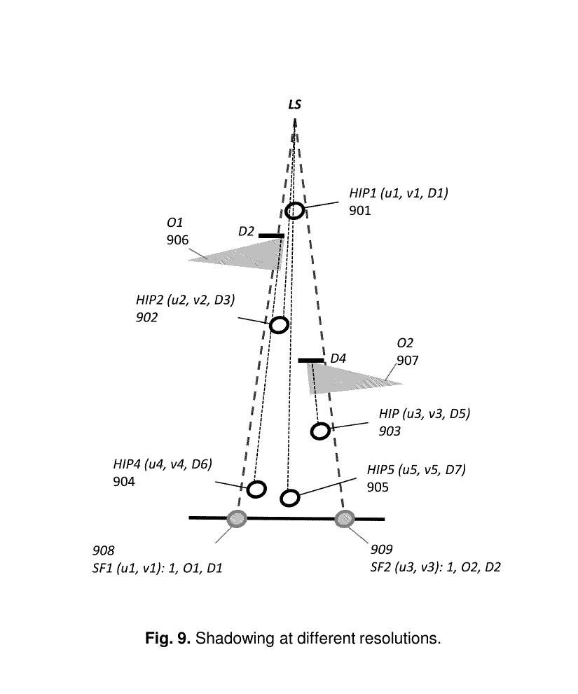

Shadowing at a non uniform resolution. The following discussion applies to all our shadowing embodiments. Despite the fact that a higher resolution of S-stencil, as compared to primitives, is recommended, there are cases that such a desirable ratio does not apply. The way the rays emit from LS toward the scene space is always perspective. The resolution among rays is getting lower with the growing distance from LS. However, the same high shadow accuracy is necessary for all HIPs, regardless of their distance from LS. Such an accuracy in some embodiments of present invention is secured by intersection tests. Intersection test, between HIP and a specific object on the way to LS, is carried out in the continuous geometrical space, yielding a precise and correct result, regardless of the resolution of the HIP's discrete neighborhood. Both the HIP and the object are geometrically defined, not aligned to the S-stencil grid. The discrete S-stencil grid serves only for identifying the candidate object. Shadowing at different resolutions is illustrated in FIG. 9. HIPs 1-5 fall within the same quadruple, and all are potentially shadowed by two objects, O1 906 and O2 907. The resolution of projected HIP's is not uniform, it depends on the HIP distance from LS. For example, HIP1 901 is more tightly surrounded by the rays (that generate S-stencil) than HIP5 905. However, thanks to intersection tests both HIPs are equally accurate shadowed. Five HIPs are shown in different positions in regard to two blocking objects O1 906 and O2 907, and at different ray resolutions. Intersection tests contribute to accurate shadowing results, keeping the shadowing correct, independently of the distance from LS. In the given example HIP1 901, HIP2 902, HIP5 905 are lit, HIP3 903 and HIP4 904 are in shadow.

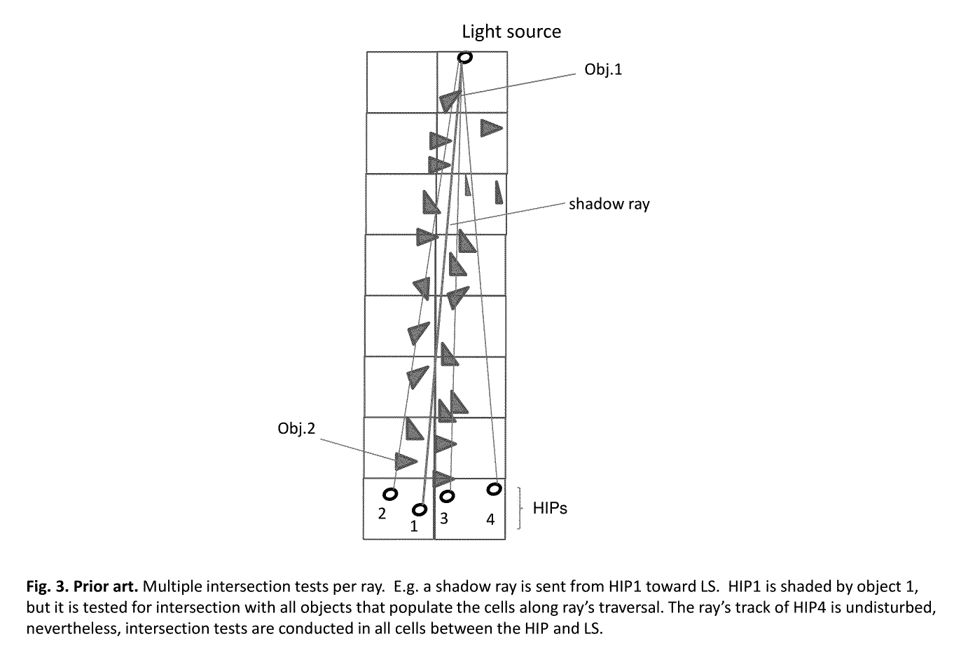

Cutting down the amount of intersection tests. A key advantage of some embodiments of present invention is an immense reduction of intersection tests, the most computationally expensive element in ray tracing. In the prior art, the needed information for shadowing a HIP is acquired by out reaching the LS by a shadowing ray. Per each HIP, along its shadowing ray, many intersection tests have potentially been done, as shown in FIG. 3.

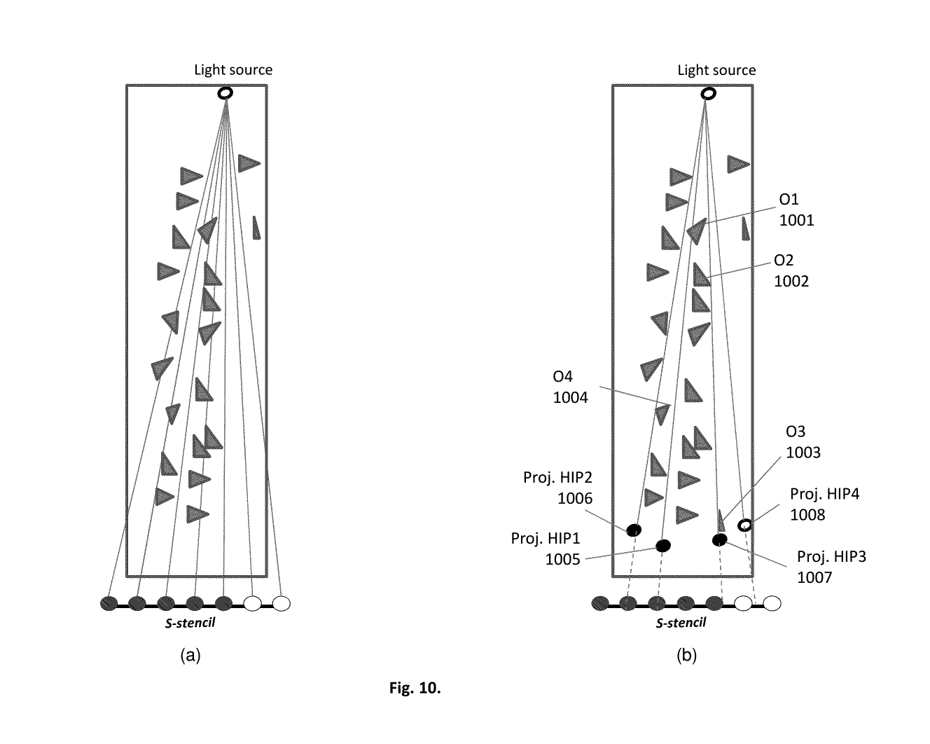

According to embodiments of the present invention, the required information is accessible locally in S-stencil. The S-stencil is created once, but used repeatedly for all HIPs. Intersection tests are required in unclear cases only, (i) when a HIP falls on a shadow's edge, or (ii) when multiple blocking objects are involved in a single quadruple. So, in many cases intersection tests are not required at all, but whenever required, it is typically one or two per HIP. These intersection tests, when required, are targeted directly to the specific object. The most amount of intersection tests per HIP is 4, but this happens only in the rare case when each of quadruple's SF is blocked by a different object. In FIG. 10, four HIPs are shown to demonstrate the frequency of using intersection tests. For simplicity, only a 2D view is shown. In FIG. 10(a) the generation of S-stencil is shown. At each SF the first light-blocking object and the depth of blocking are registered. FIG. 10(b) depicts the use of S-stencil for shadowing the HIPs. HIP1 1005 falls in the full shadow of object 1 1001, all its four surrounding SFs are shadowed, therefore it is evidently shadowed without an intersection test. HIP2 1006 falls on the edge of object 4. One intersection test is needed between HIP2 and Obj. 4 to decide if it is in shadow. HIP3 falls between two objects, 1002 and 1003. Two intersection tests are required with these objects. HIP4 1008 is surrounded by white SFs, evidently not shadowed, no intersection test is needed.

In summary, the majority of shadowing need no intersection tests. Moreover, when an intersection test is done, it is targeted directly to a specific object, the one that potentially blocks the light. No intermediate intersection tests are needed. This significant reduction of intersection tests has a major contribution to performance improvement and to energy saving in ray tracing.

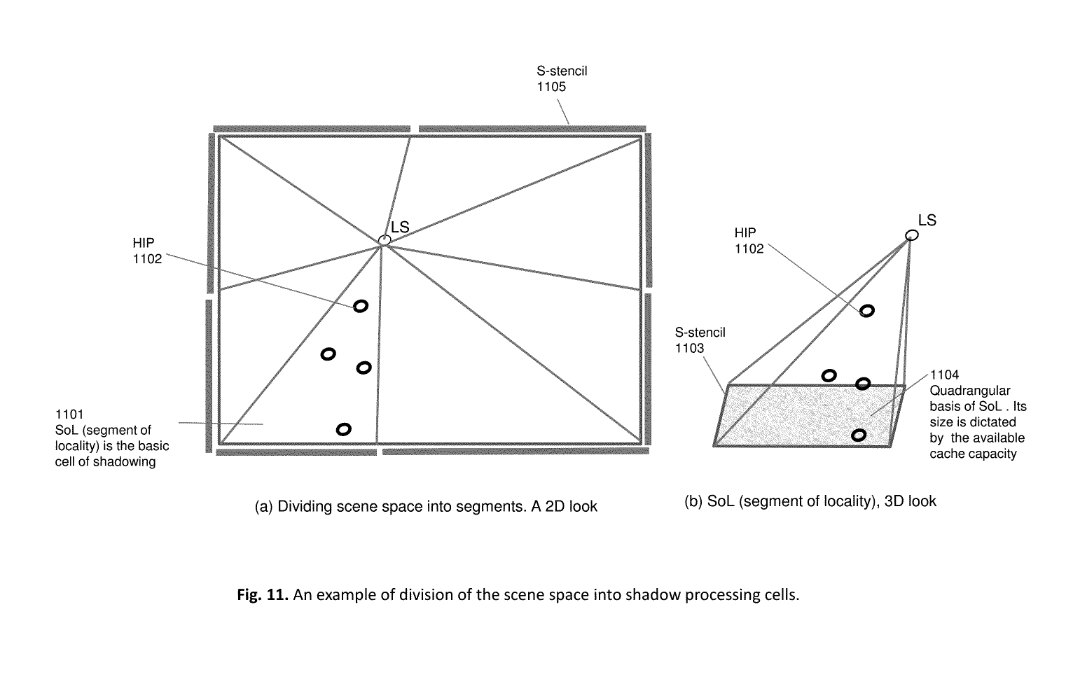

Division of the scene space. The division of a scene repeats for each light source. The scene space is divided into cells in a way that each HIP within a cell has a SF quadruple counterpart in cell's local 5-stencil, in regard to the light source. The subdivision is concentric to the light source. FIG. 11 shows one embodiment of dividing the scene space into processing cells. We term the basic shadowing cell a Segment of locality (SoL) 1101. The desirable locality is provided by local S-stencil and a cluster of HIPs 1102 populating the cell. SoL's concentric shape secures locality of stencil fragment's data for all HIPs, inside the segment. The processing of a SoL can be done by a single processing unit (or thread). The global S-stencil 1105 breaks down into multiple private parts, distributed among the SoL cells. Generation of S-stencil can be made out of its private parts locally and autonomously at each SoL cell, for all objects occupying the SoL. Run-time shadowing is done locally as well, having the private S-stencil, the local cluster of HIPs, and the local blocking objects needed for intersection tests.

For improved static load balance, the SoLs are generated in a non-uniform size, according to their HIP loads. Such a workload of HIPs is known prior to the shadowing run time, after the primary and secondary stages are completed. Other division embodiments are possible as well. E.g. the S-stencil is a solid global data, non divided into private sub-stencils, however, it must be easily accessible from the cells.

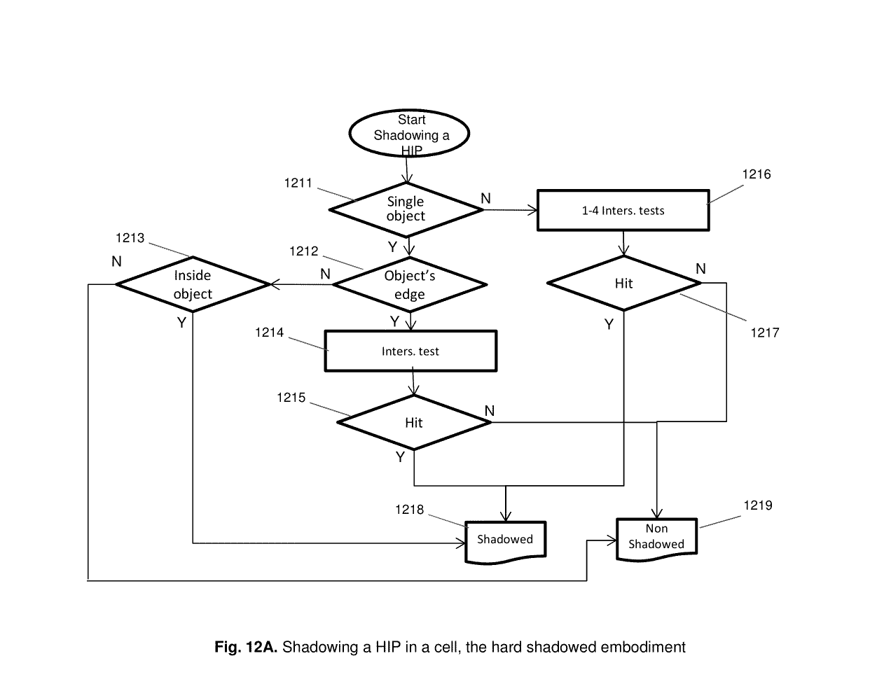

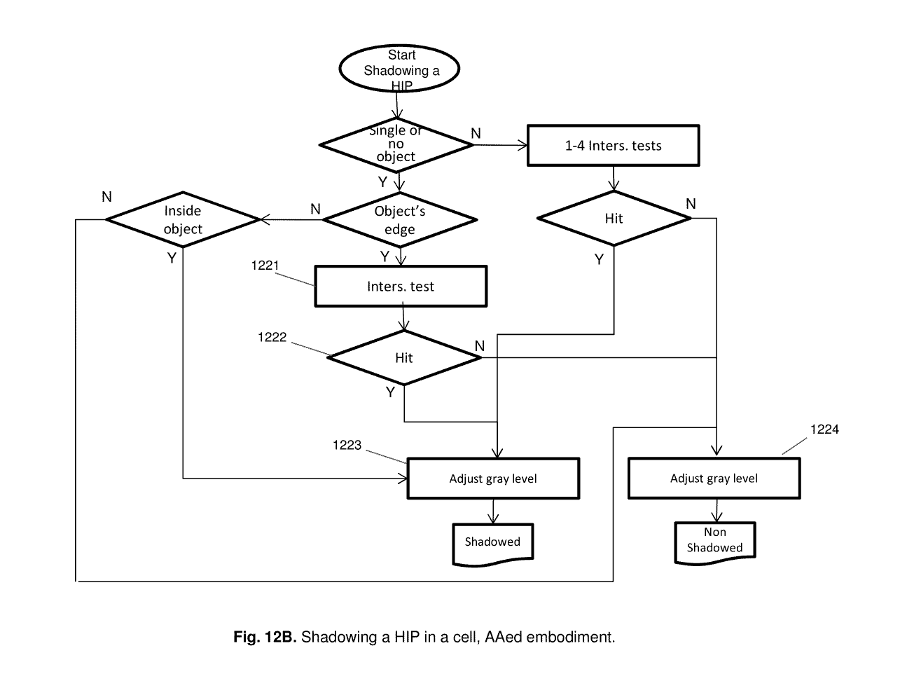

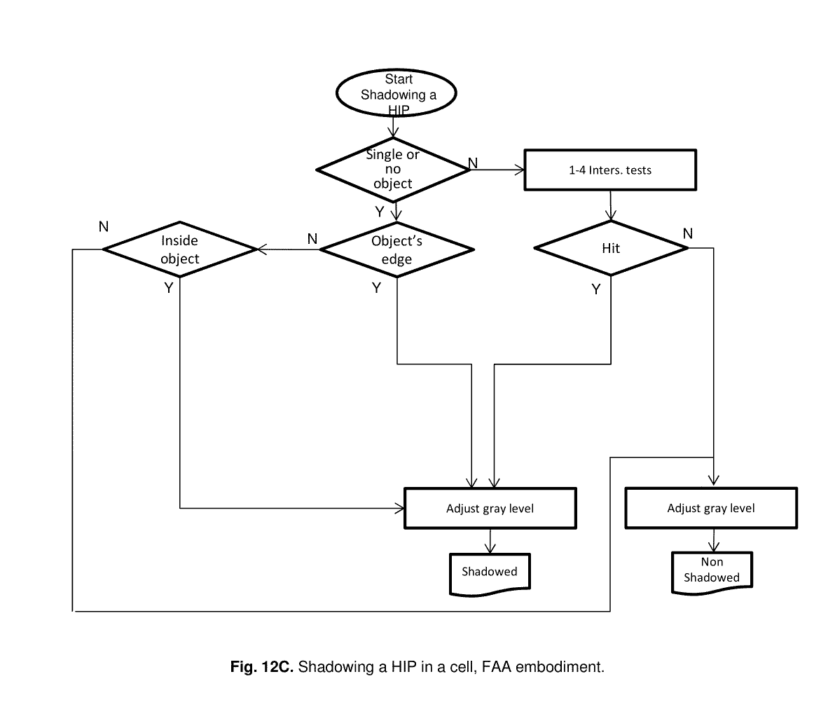

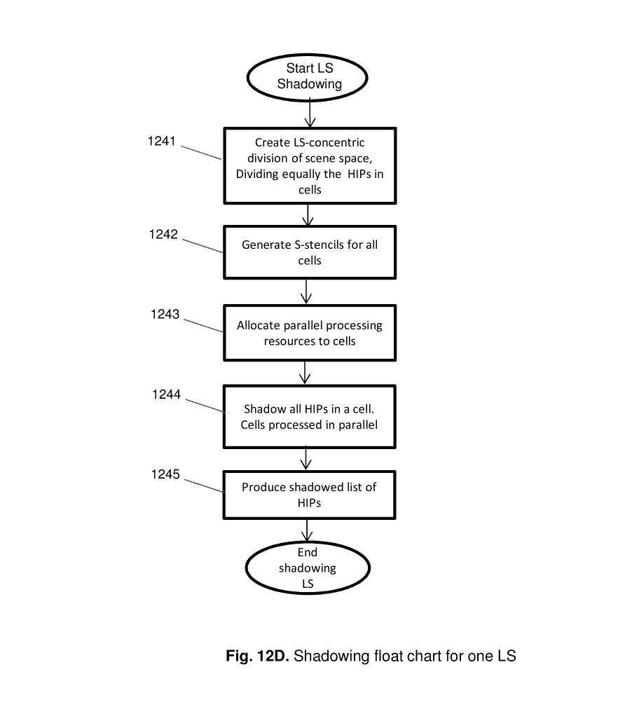

Flowchart. The shadowing of a HIP in a cell, according to the hard shadow embodiment, is flow charted in FIG. 12A. Two quadruple cases must be handled separately, blocked by a single object or blocked by 2-4 objects. For a single shadowing object 1211 we must check whether the HIP falls inside, outside or on the edge of the object. If it falls inside 1213 (all 4 SFs are shadowed by a single object), the HIP should be fully shadowed, no need to make intersection test. If outside 1213 (none of SFs is shadowed), the HIP should not be shadowed, no need to make intersection test. If the HIP falls on the edge 1212 (i.e. only part of the SFs are shadowed), an intersection test 1214, 1215 with the object must be done. If the intersection test is positive, the HIP should be shadowed 1218. For a quadruple shaded by multiple light-blocking objects (2-4 objects), a sequence of 2-4 multiple intersection tests must be done 1216. Once a test turns positive, the sequence of tests is stopped. If all tests are negative, the HIP is not shadowed 1219. The flowchart ends up with a list of shadowed and non-shadowed HIPs.

Shadowing of a HIP, according to AAed shadowing embodiment, is flow charted in FIG. 12B.As compared to the hard embodiment, it adds two blocks 1223 and 1224. The amount of intersection tests remains the same.

FIG. 12C depicts the shadowing flowchart of a HIP according to the FAA embodiment. It differs from the AAed flowchart by dropping the intersection tests in the case of a single light-blocking object. Blocks 1221 and 1222 of FIG. 12B are missing.

The entire shadow processing for HIPs in a scene, for a single light source, is given in FIG. 12D. First the scene space is divided into CoL cells by way of LS-concentric division. This step 1241 is done when all HIPs, primary as well as secondary, have been already generated in the scene space. In order to create an evenly distributed workload, the cells are created in different sizes to contain a nearly equal number of HIPs. Next 1242, S-stencil is generated, cell by cell. A cell is a concentric segment having the LS at its top (see FIG. 11), and the S-stencil at its basis. All objects in the cell are projected on a cell's basis providing its locality. Once the cells with S-stencils are made, the cells are assigned to processors, for a static load balance 1243. Each cell is processed for shadowing all its HIPs 1244 in a completely local and autonomous way. The entire scene space is computed for shadowing in a parallel distributed way. The shadowing terminates 1245 with a complete list of all HIPs along with their shadowing attributes. The above sequence repeats for all light sources in a scene. Each light source gives place into a different division of the space, according to LS location within (or out of) the scene.

Load balancing of parallel shadowing. Load balancing is a method for distributing workloads across multiple computing resources (or threads). Load balance target optimized use of processing resources, maximize throughput, minimize response time, and avoids overload of any one of the resources. Load balancing policies may be either static or dynamic. Dynamic load balancing policy reacts to the current system state, whereas static load balancing policy depends only on the average behavior of the system in order to balance the workload of the system. This makes the dynamic policy necessarily more complex and with a managing overhead, than the static one.

The prior art's attempts to load balance the uniform grids are based on the distribution of primitive objects across the grids. However, the distribution of processing load is not necessarily correlated with object distribution. E.g. one large object can hide a whole group of objects, making them invisible from the view point, aka non active. Therefore, the load balancing should consider the actual processing load, rather than distribution of objects.

As opposed to the ill attempts of prior art, the present invention devises a novel load balancing method based on the distribution of processing workload, instead of the distribution of objects as in prior art. The shadowing stage in ray tracing is the most sensitive to an ill distribution of workload. In shadowing, per each HIP, the amount of shadowing tasks matches the number of light sources. E.g. for ten light sources, ten different shadowing processes per HIP must be done. As a result, the shadowing complexity is roughly the aggregated complexity of the two other stages, multiplied by the number of light sources. Evidently, the shadowing stage is the most sensitive to a non-uniform distribution of workload. Therefore, an effective load balancing is a basic condition for an efficient implementation of ray tracing based on grid, replacing acceleration structures.

We keep a strict executing order among the three stages of ray tracing: first the primary, secondly the multiple depths of bouncing (secondary), and third the shadowing. When coming to shadowing, all primary and secondary HIPs across the scene are already known. Since the amount of required processing is about the same for each HIP, the amount of shadowing workload at a cell depends on the amount of local HIPs. This workload is known in advance, before the shadowing begins. Then, the mapping of workload distribution among cells is straight forward. The processors (or threads) are allocated to cells according to their actual workload, for an effective static load balance. At each cell, the local shadowing workload depends only on the count of local hit points. The shadowing at each cell is solved locally and independently of other cells. It is based on (i) the HIPs that populate a cell, (ii) data registered in the local S-stencil segment, and (iii) the object(s) that are subject to intersection tests, registered in the local S-stencil, and accessible in scene's database.

### Performance Comparison vs. Prior Art

Our performance analysis is based on a model developed by Vlastimil Havran (Heuristic Ray Shooting Algorithms, Czech Technical University, Prague, 2000, p.24). The analysis is of a pure shadowing task. It does not compare the time of building an acceleration tree in prior art, nor the generation of stencils in present invention.

$${T}_{R} = ( {N}_{TS} * {C}_{TS} + {N}_{IT} * {C}_{IT} ) * {N}_{rays} + {T}_{app} = ( cost of traversal + cost of intersection ) * {N}_{rays} + {T}_{app}$$

N_{TS} Average nodes accessed per ray

C_{TS} Average cost of traversal step among the nodes (incl. mem. access)

N_{IT} Average number of ray-object intersection tests per ray

C_{IT} Average cost of intersection test

Tₐₚₚ Remaining computation (same for all algorithms)

The performance model separates the cost of ray traversal and the cost of intersection tests. The last element Tₐₚₚ consists of shading and other remaining computations. Since it is the same for all algorithms, it is not part of our performance comparison.

Havran's model is applied first to a prior art algorithm and then modified and applied to our stencil based algorithm. The following ray tracing system is assumed:
A scene is subdivided into a grid of 43³, having in total 79,507 uniform cells.
The scene data comprises 1,280,000 triangles with a uniform distribution of 10 triangles/cell.
A single light source is considered.
In prior art shadowing a global KD-tree is used, and each cell is further subdivided into a grid of 2³ sub-cells, to be solved by a small local KD-tree.
C_{TS}=0.3, a traversal step for a big global KD-tree (according to Havran)
C_{TS}_{_{—}}_{local}=0.1, a traversal step for a small local KD-tree (an approximation)
C_{IT}=cost of intersection test 0.7 (according to Havran).
N_{IT}=2, two intersection tests per cell, on average.
50% of rays hit objects. Each hitting ray generates one shooting hit point (HIP). Therefore the amount of HIPs=2,000,000. No intersection points of bouncing rays are assumed.
We assume that 50% of #HIP are shadowed.
An average distance between a HIP and a light source is 34 cells. Therefore the average number of traversed cells/nodes (in the prior art) before a hit is determined is: N_{TSG}^{hit}=17 cells. In case of no hitN_{TSG}^{no hit}=34 cells.
Along the path of 34 or 17 cells, 2 local intersection tests per cell are done on average. N_{IT}=2.
An average number of local nodes accessed: N_{TSL}=6

### Prior Art Shadowing Performance

Havran's model is applied to prior art shadowing in the following way:

$${T}_{shadow} = {[ Global\_traversals + Local\_traversals + Intersection\_tests ]}^{hit} + {[ Global\_traversals + Local\_traversals + Intersection\_test ]}^{no\_hit} = {N}_{TSG}^{hit} * {C}_{TS} * \# {HIP}_{hit} + {N}_{TSG}^{hit} * ( {N}_{TSL} * {C}_{TS - local} ) * \# {HIP}_{hit} + {N}_{TSG}^{hit} * ( {N}_{IT} * {C}_{IT} ) * \# {HIP}_{hit} + {N}_{TSG}^{no hit} * {C}_{TS} * \# {HIP}_{no - hit} + {N}_{TSG}^{no hit} * ( {N}_{TSL} * {C}_{TS - local} ) * \# {HIP}_{no - hit} + {N}_{TSG}^{no hit} * ( {N}_{IT} * {C}_{IT} ) * \# {HIP}_{no - hit} = \# {HIP}_{hit} * {N}_{TSG}^{hit} ( {C}_{TS} + {N}_{TSL} * {C}_{TS - local} + {N}_{IT} * {C}_{IT} ) + \# {HIP}_{no - hit} * {N}_{TSG}^{no hit} ( {C}_{TS} + {N}_{TSL} * {C}_{TS - local} + {N}_{IT} * {C}_{IT} )$$

$${T}_{shadow} = 2 \text{,} 000 \text{,} 000 * 17 * ( 0.3 + 6 * 0.3 + 2 * 0.7 ) + 2 \text{,} 000 \text{,} 000 * 34 * ( 0.3 + 6 * 0.3 + 2 * 0.7 ) = 357 \text{,} 000 \text{,} 000$$

$$Out of the total time {T}_{shadow} , the intersection tests take 142 \text{,} 800 \text{,} 000 units .$$

### Performance of the Hard Shadowing Embodiment

The previously used shadowing model must be modified to match the stencil algorithm. But first we apply the flowchart parts of FIG. 12A to estimate the amount of intersection tests. Following the prior art analysis: there are 2,000,000 HIPs, whereas 50% of these HIPs are not shadowed (1,000,000). 50% of all HIPs that are not shadowed break down into 25%, that fall out of blocking objects, i.e. do not need intersection tests, and 25% that need 1 intersection test each. The other 50% of all HIPs that are shadowed, break down to (i) 30% blocked by a single object, further divided to 15% inside an object that do not need intersection test, and (ii) 20% blocked by 2 objects, requiring 2 intersection tests each. We assume that the number of HIPs blocked by 3 or 4 objects is negligible.

The cost model of our hard shadowing embodiment, similarly to Havran's model, states the basic cost:

(K_{HIPs}*C_{IT}+K_{stencil})*N_{HIPs}.

K_{HIPs} stands for an average number of intersection tests per HIP, and K_{stencil} for the cost of examining a quadruple of SFs. We assume that K_{stencil} has a flat value of 0.1. Here are the weights of different K_{HIPs}.

K_{NS}_{_{—}}_{O}=0, non shadowed K_{HIPs}, they fall out of the object, no intersection test

K_{NS}_{_{—}}_{E}=1, non shadowed K_{HIPs}, fall on the edge of a single object, needs 1 intersection test

K_{S}_{_{—}}_{E}=1, shadowed K_{HIPs}, fall on the edge of a single object, needs 1 intersection test

K_{S}_{_{—}}_{I}=0, shadowedK_{HIPs}, fall inside a single object, no intersection test

K_{S}_{_{—}}_{M}=2, shadowed K_{HIPs} by multiple objects, needs 2 intersection tests on average.

$${T}_{shadow} = ( {K}_{NS\_O} * {C}_{IT} + {K}_{stencil} ) {N}_{NS\_O} + ( {K}_{NS\_E} * {C}_{IT} + {K}_{stencil} ) {N}_{NS\_E} + ( {K}_{S\_E} * {C}_{IT} + {K}_{stencil} ) {N}_{S\_E} + ( {K}_{S\_I} * {C}_{IT} + {K}_{stencil} ) {N}_{S\_I} + ( {K}_{S\_M} * {C}_{IT} + {K}_{stencil} ) {N}_{S\_M} = ( 0 * 0.7 + 0.1 ) * 500 , 000 + ( 1 * 0.7 + 0.1 ) * 500 , 000 + ( 1 * 0.7 + 0.1 ) * 300 , 000 + ( 0 * 0.7 + 0.1 ) * 300 , 000 + ( 2 * 0.7 + 0.1 ) * 400 , 000 = 50 , 000 + 400 , 000 + 240 , 000 + 30 , 000 + 600 , 000 = 1 , 320 , 000$$

The cost of intersection tests out of the overall cost is 1,120,000.

These results are comparable to the prior art shadowing cost of 357,000,000, and intersection tests cost of 142,000,000. This is an improvement of ×270, which is about 2 levels of magnitude. The performance results reflect two key advantages of the present invention embodiments: abandonment of expensive acceleration structure traversals, and a vast reduction of intersection tests.

What is claimed is:

1. A method to generate shadowing in a scene space as a separate stage of ray tracing in a computer graphics system, comprising the steps of:
[1a] per each light source
[1] subdividing the scene space to non-uniform cells;
[1b] generating shadow stencils in cells;
[1c] assigning processing resources to a cell;
[1d] shadowing all hit points in a cell;
[1e] repeating steps and for all cells, until shadowing of the scene space is completed;
[2] repeating step [2] for all light sources;
[3] wherein, step 1 starts upon completion of primary and secondary stages of ray tracing.

2. The method of claim 1, wherein said subdivision of the scene space into cells is done concentrically with a light source.

3. The method of claim 1, wherein said subdivision of scene space into non-uniform cells is done according to the load of hit points.

4. The method of claim 3, wherein said hit points are evenly distributed among said cells.

5. The method of claim 3, wherein said hit points are results of primary and secondary stages of ray tracing.

6. The method of claim 4, wherein an even distribution of hit points among cells assists in a static load balancing of a working load.

7. The method of claim 1, wherein cell's shadow stencil holds identification of a light blocking objects.

8. A ray tracing system having shadowing made as a separate stage, comprising:
[1] one or more processors with memory,
[2] scene data subdivided into non-uniform cells,
[3] shadow stencils in cells;
[4] processing resources assigned to cells;
Wherein, said separate step of shadowing takes place after primary and secondary stages are completed, and their generated workload of hit points is known.

9. The system of claim 8, wherein said cells are concentric with a light source.

10. The system of claim 8, wherein said scene space is sub-divided into non-uniform cells according to the load of hit points.

11. The system of claim 8, wherein said hit points are evenly distributed among said cells.

12. The system of claim 8, wherein said workload of hit points is evenly distributed among cells for a static load balance.

13. The system of claim 8, wherein shadow stencils in cells hold identification of a light blocking objects.

14. The method of claim 8, wherein said shadow stencil is a discrete raster of fragments, each fragment holding an information on light blocking, and identification and depth of blocking object.
